(19) United States
(12) Patent Application Publication
(10) Pub. No.: US 2011/0090150 A1
(43) Pub. Date: Apr. 21, 2011

(54) INPUT PROCESSING DEVICE

(75) Inventors: Toshio KAWANO, Miyagi-Ken (JP); Hiroshi Shigetaka, Miyagi-Ken (JP)

(73) Assignee: ALPS ELECTRIC CO., LTD, Tokyo (JP)

(21) Appl. No.: 12/903,691

(22) Filed: Oct. 13, 2010

(30) Foreign Application Priority Data
Oct. 21, 2009 (JP) 2009-242056

(51) Int. Cl. G06F 3/033

(52) U.S. Cl. 345/161

(57) ABSTRACT

An input processing device includes a touch pad that detects a touch position of a finger, at least two button operation units that are provided around the touch pad, a pad signal processing unit that processes a detection signal from the touch pad to generate a pad signal and processes a detection signal from the button operation units to generate a button signal, a stick pointer that is provided at a position farther away from a user than the touch pad and detects an operation in the tilting direction, a stick signal processing unit that processes a detection signal from the stick pointer to generate a stick signal, and, an operation signal generating unit that receives the pad signal, the button signal, and the stick signal.

### CROSS REFERENCE TO RELATED APPLICATION

The present invention contains subject matter related to and claims the benefit of Japanese Patent Application JP 2009-242056 filed in the Japanese Patent Office on Oct. 21, 2009, the entire contents of which is incorporated herein by reference.

### BACKGROUND OF THE DISCLOSURE

1. Technical Field

Embodiments of the disclosure relate to an input processing device provided with a touch pad detecting a touch position of a finger and a stick pointer detecting that a stick is pressed and tilted in a direction by a finger.

2. Related Art

An operation input unit of a laptop personal computer is disclosed in U.S. Pat. No. 6,681,268. The operation input unit is provided with a keyboard device on which a plurality of keys are arranged, a touch pad detecting a touch position of a finger, and a stick pointer pressed and tilted by a finger.

The touch pad detects the touch position of the finger in response to a change in electrostatic capacity when the operation face is touched with the finger. In an operation signal generating unit, a movement instruction signal moving a cursor displayed on a screen is generated on the basis of a detection signal of the touch pad. As described in U.S. Pat. No. 6,681,268, button operation units are provided at least at two locations on the front side of the touch pad when viewed from an operator. By operating the touch pad to move the cursor displayed on the screen to a position of a menu and pressing the button operation unit, a pull-down menu can be opened or the menu can be determined.

The stick pointer is provided among the keys of the keyboard device. When the stick pointer is tilted forward, backward, left, and right, strain at that time is detected by a resistor-type strain sensor. A movement instruction signal moving the cursor is generated on the basis of the detection signal in the same manner as the time of operating the touch pad. After the cursor is moved by operating the stick pointer, an operation of opening the pull-down menu or an operation of determining the menu are performed by pressing at least two button operation units only for the stick pointer provided around the stick pointer.

The input processing device described in U.S. Pat. No. 6,681,268 has no button operation unit only for the stick pointer. Accordingly, in this case, the button operation units provided on the front side of the touch pad are also used as button operation units for the stick pointer.

Recently, the input operation unit of the personal computer has been getting smaller, and the area of the operation face of a touch pad is getting wider to be more easily operated. For this reason, it is difficult for the input operation unit to be provided with a pressing operation unit only for the stick pointer in consideration of space.

When the pressing operation units provided on the front side of the touch pad are also used as pressing operation units for the stick pointer, the stick pointer and the pressing operation units are too far away from each other, and it is difficult to continuously operate the stick pointer and the pressing operation units.

These and other drawbacks exist.

### SUMMARY OF THE DISCLOSURE

Various embodiments provide an input processing device that can perform operation of a stick pointer and an accompanying button operation of the stick pointer at positions close to each other, without providing a pressing operation unit only for the stick pointer.

According to an embodiment, an input processing device includes: a touch pad that detects a touch position of a finger; at least two button operation units that are provided around the touch pad; a pad signal processing unit that processes a detection signal from the touch pad to generate a pad signal and processes a detection signal from the button operation units to generate a button signal; a stick pointer that is provided at a position farther away from a user than the touch pad and detects an operation in the tilting direction; a stick signal processing unit that processes a detection signal from the stick pointer to generate a stick signal; and an operation signal generating unit that receives the pad signal, the button signal, and the stick signal, wherein in the operation signal generating unit, a movement instruction signal about information displayed on a screen is generated when receiving the pad signal, a determination signal associated with the movement instruction signal based on the pad signal is generated when receiving the button signal, a movement instruction signal about information displayed on the screen is generated and the pad signal is recognized as a pseudo-button signal when receiving the stick signal, a determination signal is generated associated with the movement instruction signal based on the stick signal is generated when receiving the pseudo-button signal.

When the stick pointer is used, the touch pad provided on the front side is touched with the finger to generate the pseudo-button signal, and thus various input operations are possible by the stick signal and the pseudo-button signal. Because it is not necessary to provide a button device only for the stick pointer, it is possible to efficiently use the space of the operation input unit. And because the stick pointer and the touch pad generating the pseudo-pressing signal can be closely provided, it is easy to operate the stick pointer.

In an input processing device according to various embodiments, several areas of the operation face of the touch pad are set as button operation areas, and the pad signal is recognized as the pseudo-button signal when the button operation area is touched with a finger. In this case, the position and the size of the button operation area are set by an operation signal.

Also, the operation signal generating unit recognizes whether a touch pad operation mode is set or a stick pointer operation mode is set, the movement instruction signal is generated by the pad signal when the touch pad operation mode is set, and the pseudo-button signal is generated by the pad signal when the stick pointer operation mode is set.

In such an embodiment, the touch pad operation mode and the stick pointer operation mode are switched to each other by an operation signal.

The input processing device according to various embodiments may further include a feedback mechanism that gives feedback power to the touch pad when the stick pointer operation mode is set and it detects that the touch pad is touched with the finger.

The input processing device according to various embodiments may further include a switch that operates when at least a part of the touch pad is pressed, and the pseudo-button signal is generated when receiving a detection signal of the switch.

When a part of the touch pad is provided with the switch, it is possible to reliably generate the pseudo-button signal by pressing the touch pad to operate the switch while operating the stick pointer.

Additionally, a cursor displayed on the screen is moved by the movement instruction signal, and a detailed menu corresponding to a position instructed by the cursor is displayed by the determination signal or a selected menu is determined by the determination signal.

However, information displayed on the screen by the movement instruction signal can be scrolled, and the scrolling can be performed by the button signal or the pseudo-button signal.

Since it is not necessary to provide a button operation device only for the stick pointer, it is possible to efficiently use the space of the input operation unit. Accordingly, the size of the input processing unit can be reduced, or the operation face of the touch pad can be widened.

Since the pseudo pressing signal for the stick pointer is generated by the operation of the touch pad, it is easy to continuously operate with a finger the stick pointer and the touch pad provided close to each other.

### BRIEF DESCRIPTION OF THE DRAWINGS

FIG. 1 is a perspective view illustrating a personal computer provided with an input processing device according to various embodiments of the disclosure.

FIG. 2A and FIG. 2B are diagrams illustrating examples of setting a button operation area in a touch pad.

FIG. 3 is a cross-sectional view illustrating a touch pad provided with a feedback mechanism according to an embodiment of the disclosure.

FIG. 4 is a perspective view illustrating a structure of a stick pointer according to an embodiment of the disclosure.

FIG. 5 is a circuit diagram illustrating a strain sensor provided in the stick point according to an embodiment of the disclosure.

FIG. 6 is a circuit block diagram illustrating the input processing device according to various embodiments of the disclosure.

FIG. 7A is a diagram illustrating an example of an image of an input setting menu of a switching input unit of a touch pad operation mode and a stick pointer operation mode according to an embodiment of the disclosure.

FIG. 7B is a diagram illustrating an example of an image of a menu for setting a button operation area in the touch pad according to an embodiment of the disclosure.

FIG. 8 is a diagram illustrating another example of setting a button operation area in the touch pad according to an embodiment of the disclosure.

FIG. 9 is a diagram illustrating an exemplary of setting a button operation area in the touch pad according to an embodiment of the disclosure.

FIG. 10A is a plan view illustrating a touch pad provided with switches according to an embodiment of the disclosure.

FIG. 10B is a cross-sectional view illustrating the touch pad according to an embodiment of the disclosure.

FIG. 11A is a plan view illustrating an example of a configuration of a touch pad provided with switches according to an embodiment of the disclosure.

FIG. 11B is a cross-sectional view illustrating a touch pad according to an embodiment of the disclosure.

FIG. 12A is a plan view illustrating an example of a configuration of a touch pad provided with a switch according to an embodiment of the disclosure.

FIG. 12B is a cross-sectional view illustrating a touch pad according to an embodiment of the disclosure.

### DETAILED DESCRIPTION OF THE DISCLOSURE

The following description is intended to convey a thorough understanding of the embodiments described by providing a number of specific embodiments and details involving an input processing device. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

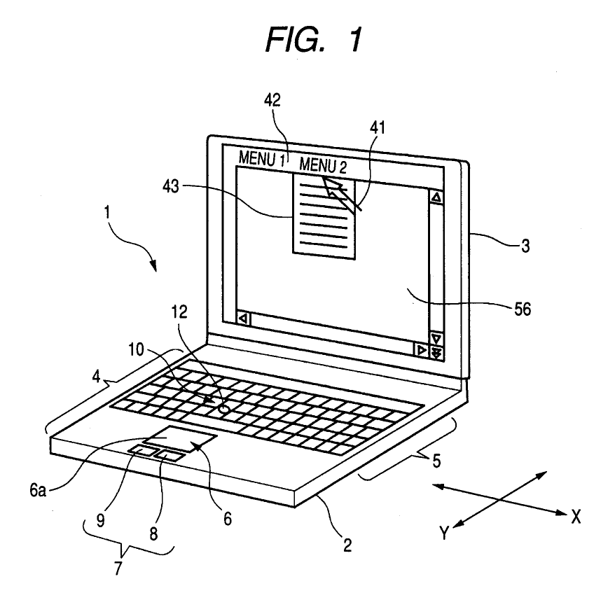

A personal computer 1 shown in FIG. 1 may be provided with a body unit 2 and a cover unit 3 that may be foldably connected. An operation input unit 4 may be provided on a surface of the body unit 2, and a display screen 56 of a display device 55 formed of a liquid crystal display panel may be provided on a face opposed to the front side of the cover unit 3.

The operation input unit 4 may be provided with a keyboard input unit 5, a touch pad 6, a button operation unit 7, and a stick pointer 10.

In the keyboard input unit 5, a plurality of keys may be regularly arranged in the transverse direction (X direction) and the longitudinal direction (Y direction). Press switches may be provided individually under the keys. When several keys are pressed, the detected output of switches thereunder may be converted.

A user may face the display screen 56. The touch pad 6 may be provided further to front side than the keyboard input unit 5 as viewed from the user. The touch pad 6 may have a rectangular operation face 6a, and can detect change in electrostatic capacity when the operation face 6a is touched with a finger. The button operation unit 7 may be provided even further to the front side than the touch pad 6. The button operation unit 7 may be provided with at least two buttons. In the operation input unit 4 shown in FIG. 1, the button operation unit 7 may be provided with two buttons of a right button 8 and a left button 9. However, the button operation unit 7 may be provided with three or more buttons.

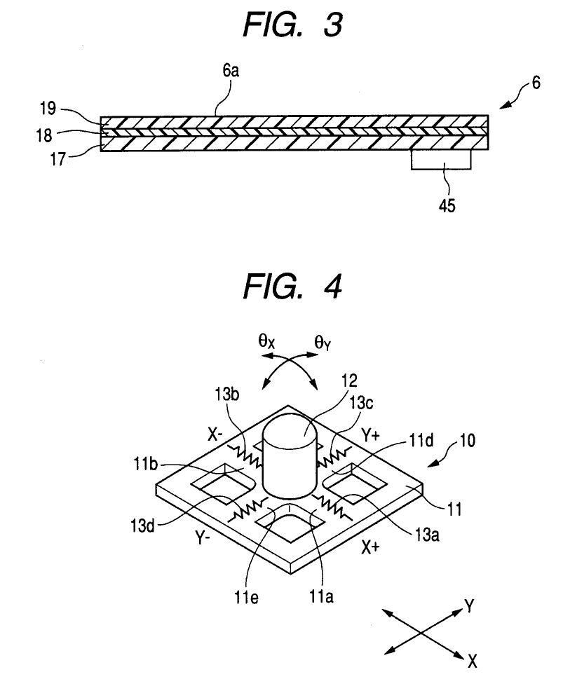

As shown in FIG. 3, the touch pad 6 may be provided with an insulating layer 18 that may be formed on a surface of a rigid insulating substrate 17, a plurality of X electrodes arranged in the X direction may be formed on one side of upper and lower sides with the insulating layer 18 therebetween, and a plurality of Y electrodes arranged in the Y direction may be formed on the other side. Detection electrodes may be formed between X electrodes adjacent to each other, the detection electrodes and the X electrodes may be insulated from each other and opposed in parallel, and the detection electrodes and the Y electrodes may be insulated from and cross over each other. An insulating cover sheet 19 may be provided on surfaces of the electrodes, and a surface of the cover sheet 19 may serve as the operation face 6a.

The touch pad may be provided with a driving circuit, pulse-phase voltage is sequentially applied to the plurality of X electrodes, and at the other time, pulse-phase voltage is applied to the plurality of Y electrodes. When the operation face 6a is touched with a user's finger that is a conductor of substantially ground potential, electrostatic capacity may be formed between the finger and the electrodes. When the operation face 6a is touched with the finger in the vicinity of the X electrodes or the Y electrodes to which the pulse-phase voltage is applied, voltage or current between the X electrode to which the pulse voltage is applied and the detection electrode is changed by the change of the electrostatic capacity, and similarly, voltage or current between the Y electrode to which the pulse voltage is applied and the detection electrode is changed. The change of the voltage or the change of the current may be taken out through the detection electrode. When the change of the voltage or the change of the current is detected from the detection electrode, it may be possible to detect the position on the operation face 6a touched with the finger on X-Y coordinates by obtaining time information that voltage is applied to which electrode of X electrode or Y electrode.

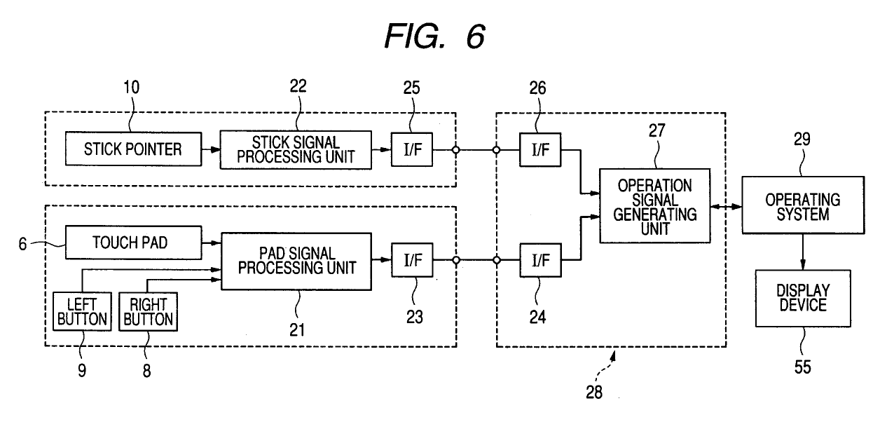

As shown in FIG. 6, the detection signal of the touch pad 6 may be transmitted to a pad signal processing unit 21 formed of a CPU and a memory of a microcomputer, and a pad signal may be generated from the pad signal processing unit 21. The pad signal may be generated by converting position information of the finger and movement information of the finger on the X-Y coordinates detected by the touch pad 6 into a relative coordinate signal representing a movement direction and a movement distance. The pad signal may be the same kind as that of the detection signal of a mouse that is an external operation device connected to the personal computer 1. However, for the pad signal processing unit 21, an absolute coordinate signal on the X-Y coordinates may be output as the pad signal on the basis of the detection signal of the touch pad 6.

Switches may be provided under the right button 8 and the left button 9 of the button operation unit 7, a button signal at the time of operating each switch may be transmitted to the pad signal processing unit 21 shown in FIG. 6. In the pad signal processing unit 21, a button signal based on the detection operation of the switch may be generated. In the pad signal processing unit 21, predetermined-byte number format data including the pad signal that is the relative coordinate signal, or the pad signal that is the position signal on the absolute coordinates, and the button signal may be generated.

FIG. 4 shows a schematic structure of the stick pointer 10. The stick pointer 10 may have a base 11 formed of synthetic resin, for example, and the base 11 may be integrally provided with a plus X deformation portion 11a and a minus X deformation portion 11b extending in the X direction, and a plus Y deformation portion 11d and a minus Y deformation portion 11e extending in the Y direction. An operation protrusion 12 protruding upward may be integrally formed at the center of the base 11. The operation protrusion 12 may be formed at the center of the plus X deformation portion 11a, the minus X deformation portion 11b, the plus Y deformation portion 11d, and the minus Y deformation portion 11e. In the operation input unit 4 shown in FIG. 1, the operation protrusion 12 may protrude between keys of the keyboard input unit 5 adjacent to each other.

A plus X strain sensor 13a may be provided on a surface of the plus X deformation portion 11a, and a minus X strain sensor 13b may be provided on a surface of the minus X deformation portion 11b. Similarly, a plus Y strain sensor 13c may be provided on a surface of the plus Y deformation portion 11d, and a minus Y strain sensor 13d may be provided on a surface of the minus Y deformation portion 11e.

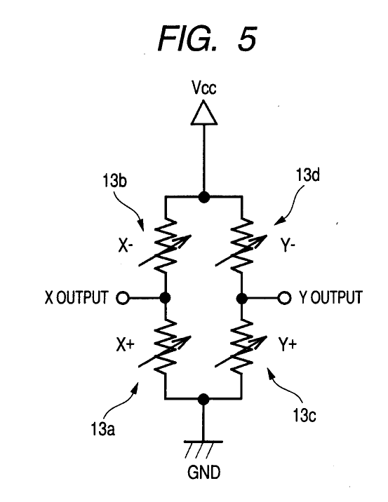

Each of the strain sensors 13a, 13b, 13c, and 13d may be a resistance film. The strain sensors 13a, 13b, 13c, and 13d may be connected to each other to form a bridge circuit shown in FIG. 5. An X output and a Y output of the bridge circuit may be converted into digital signals in an A/D conversion unit, and the digital signals may be transmitted to a stick signal processing unit 22 shown in FIG. 6.

In FIG. 4, when the operation protrusion 12 is pressed to be tilted in a θx direction, a θy direction, or the other direction, resistance values of the strain sensors 13a, 13b, 13c, and 13d may be changed in response to the pressing direction and pressing force. Thus, the X output and the Y output may be obtained from the bridge circuit shown in FIG. 5. The X output and the Y output may be vectors represented by components of the X direction and the Y direction, and represent the operation direction and the operation force in the operation direction. When the X output and the Y output maybe transmitted to the stick signal processing unit 22, the stick signal processing unit 22 may generate a stick signal that may be a relative coordinate signal representing the movement direction and the movement distance, for example. The stick signal may be the same kind as that of the detection signal of the mouse. For the stick signal processing unit 22, predetermined-byte number format data may be generated.

As shown in FIG. 6, driver software 28 may be installed in a main control unit of the body unit 2 of the personal computer 1. The driver software 28 may include an operation signal generating unit 27. The format data including the pad signal and the button signal generated by the pad signal processing unit 21 may be output from an output interface unit 23, the format data may be input to the main control unit of the personal computer 1 through an input interface unit 24, and may be transmitted to the operation signal generating unit 27. The format data including the stick signal generated by the stick signal processing unit 22 also may be transmitted to the operation signal generating unit 27 through the output interface unit 25 and the input interface unit 26.

The operation signal generating unit 27 may generate an operation signal from the pad signal, the button signal, and the stick signal. The operation signal may be transmitted to an operating system 29 installed in the main control unit of the personal computer 1.

The operating system 29 may perform a basic operation process of the personal computer 1, and the display device 55 having the display screen 56 shown in FIG. 1 may be controlled by the operating system 29.

Next, an input operation of the personal computer 1 will be described.

An operator can select and set a touch pad operation mode or a stick pointer operation mode in advance.

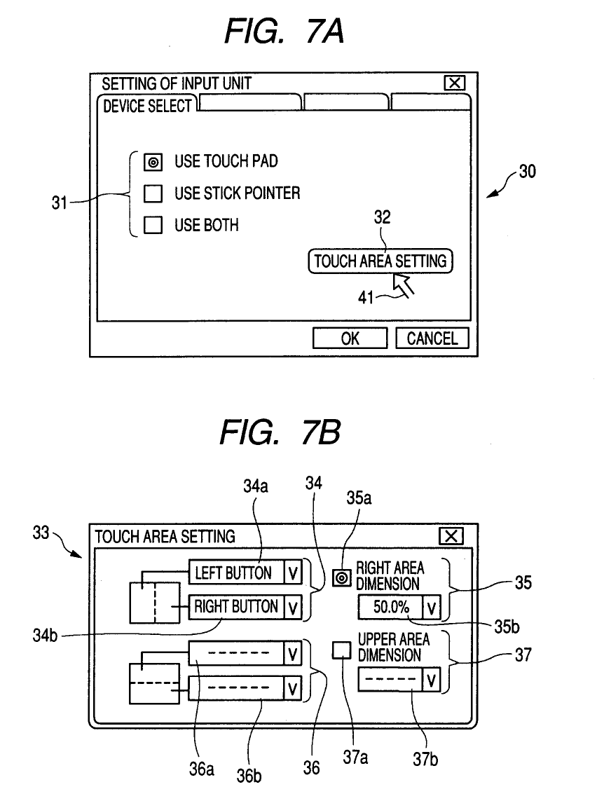

The operator finds various kinds of mode setting menu by operating the keyboard input unit 5, the touch pad 6 or the stick pointer 10 which is activated at that time, and an image of an input unit setting menu 30 as shown in FIG. 7A is displayed on the display screen 56. The operation signal generating unit 27 shown in FIG. 6 may read image information from a memory and may transmit the image information to the operating system 29, thereby displaying the image of the input unit setting menu 30 on the display screen 56. When the image of the input unit setting menu 30 is displayed, selection of the operation mode and detailed setting of the operation mode can be performed by operating the keyboard input unit 5, and the touch pad 6 or the stick pointer 10 that is activated at that time.

The image of the input unit setting menu 30 shown in FIG. 7A may include a device selection section 31. When a “use touch pad” item is selected in the device selection section 31, a touch pad operation mode may be set for the operation signal generating unit 27 shown in FIG. 6. When a “use stick pointer” item is selected in the device selection section 31, a stick pointer operation mode may be set. When a “use both” item is selected, the operation signal can be input by operating both the touch pad 6 and the stick pointer 10 concurrently.

When the touch pad operation mode is set, the operation signal generating unit 27 may generate an operation signal on the basis of the pad signal and the button signal transmitted from the pad signal processing unit 21.

In the touch pad operation mode, a movement instruction signal may be generated from the pad signal that may be the relative coordinate signal, in the operation signal generating unit 27. As shown in FIG. 1, when the cursor 41 is displayed on the display screen 56, the cursor 41 can be moved by the movement instruction signal. That is, the cursor 41 can be moved by touching the operating face 6a of the touch pad 6 with a finger and moving the finger on the operation face 6a.

When the cursor 41 is moved to the menu display 42 and the right button 8 or the left button 9 is pressed to transmit the button signal from the pad signal processing unit 21 to the operation signal generating unit 27, the operation signal generating unit 27 may output a determination signal. A pull-down menu 43 corresponding to the menu display 42 may be displayed on the display screen 56 by the determination signal. When the finger is moved downward or upward on the operation face 6a of the touch pad 6, the operation signal generating unit 27 may generate a movement instruction signal on the basis of the pad signal and several items of the pull-down menu 43 are selected. After the selection, when the right button 8 or the left button 9 is pressed, the operation signal generating unit 27 may generate a determination signal to execute the function corresponding to the selected item.

When a plurality of icons is displayed on the display screen 56, the cursor 41 can be moved to positions of several icons by the movement instruction signal. When the right button 8 or the left button 9 is pressed to generate the button signal, a program corresponding to the icon may be executed.

When word processing software is activated, after inputting characters by the keyboard input unit 5, conversion candidates of Chinese characters, for example, can be determined by pressing the right button 8 or the left button 9 to output a determination signal. Display of a character line can be scrolled using the pad signal when operating the operation face 6a with the finger, and the display of the character line can be scrolled by pressing the right button 8, the left button 9, or a third button provided on the button operation unit 7.

When “use stick pointer” on the device selection section 31 of the input unit setting menu 30 shown in FIG. 7A is selected to set the stick pointer operation mode, a touch area setting section 32 included in the input unit setting menu 30 may be activated and brightly displayed. For example, when the cursor 41 is allowed to correspond to the touch area setting section 32 by operating the touch pad 6 with a finger and the right button 8 or the left button 9 is pressed, a touch area setting menu 33 shown in FIG. 7B may be displayed together with the input unit setting menu 30 on the display screen 56.

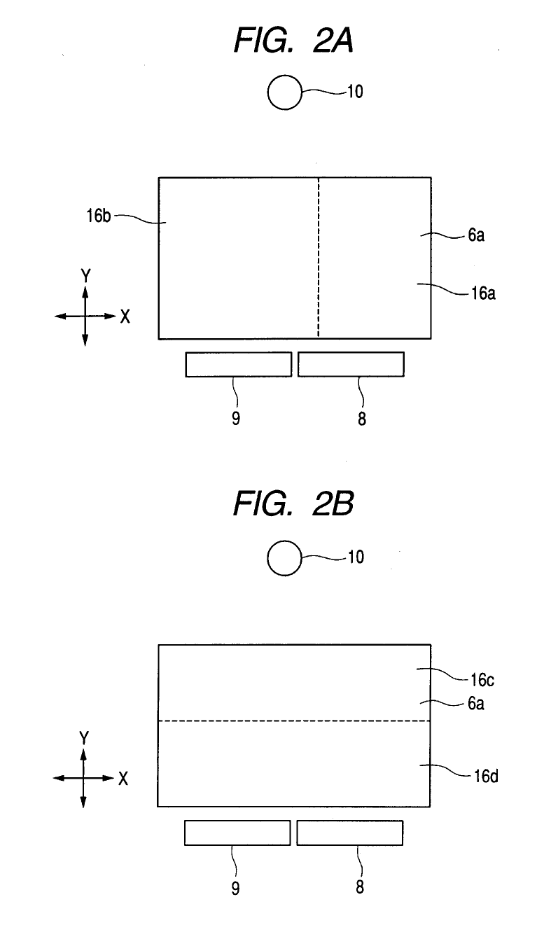

For a left and right division setting section 34 of the touch area setting menu 33, when “right button” and “left button” may be assigned to a setting range 34a and a setting range 34b, as shown in FIG. 2A, a right area of the operation face 6a of the touch pad 6 may be set as a right button operation area 16a and a left area of the operation face 6a may be set as a left button operation area 16b. When the areas are set by the left and right division setting section 34 and the cursor is moved to a check section 35a of a dimension assignment section 35 and the right button 8 or the left button 9 is pressed and checked to designate a right area dimension to a dimension ratio designating section 35b, the ratio of dimensions of the right button operation area 16a and the left button operation area 16b can be changed.

For an up and down division setting section 36 of the touch area setting menu 33 shown in FIG. 7B, when “right button” and “left button” are assigned to a setting range 36a and a setting range 36b, as shown in FIG. 2B, an upper area of the operation face 6a of the touch pad 6 may be set as a right button operation area 16c and a lower area of the operation face 6a may be set as a left button operation area 16d. Also in this case, the dimension ratio of the right button operation area 16c and the left button operation area 16d shown in FIG. 2B can be changed by checking a check section 37a of a dimension assignment section 37 to designate the right area dimension by a dimension ratio designating section 37b.

After performing the area setting of the operation face 6a of the touch pad 6 for the stick pointer operation mode as described above, when the operation protrusion 12 of the stick pointer 10 is pressed in the X direction and the Y direction, a stick signal of the relative coordinate data may be transmitted from the stick signal processing unit 22 to the operation signal generating unit 27.

The operation signal generating unit 27 may generate a movement instruction signal on the basis of the stick signal. The movement instruction signal may be the same as the movement instruction signal generated when the touch pad 6 is operated in the touch pad operation mode. As described above, a control process may be performed such as moving the cursor 41 displayed on the display screen 56 by the movement instruction signal.

When the stick pointer operation mode is set and the operation face 6a of the touch pad 6 is touched with a finger to transmit the pad signal from the pad signal processing unit 21 to the operation signal generating unit 27 in association with the operation of the stick pointer 10, it may be determined which area of the operation face 6a is touched with the finger from the pad signal. When it is determined that the right button operation area 16a shown in FIG. 2A or the right button operation area 16c show in FIG. 2B is touched with the finger, the pad signal at that time may be recognized as a right pseudo-button signal. When it is determined that the left button operation area 16b or the left button operation area 16d is touched with the finger, the pad signal at that time may be recognized as a left pseudo-button signal.

The right pseudo-button signal may correspond to a button signal at the time of pressing the right button 8, and the left pseudo-button signal may correspond to a button signal at the time of pressing the left button 9. When the pseudo-button signal is generated from the operation signal generating unit 27, a determination signal may be generated in the touch pad operation mode in the same manner as the time of obtaining the button signal and the determination signal is transmitted to the operating system 29.

Accordingly, the stick pointer 10 may be operated to transmit the stick signal to the operation signal generating unit 27. After the cursor 41 is moved to the display screen 56, when the operation face 6a of the touch pad 6 is touched with a finger, a pseudo-button signal equivalent to the button signal of the right button 8 is recognized or a pseudo pressing signal equivalent to the button signal of the left button 9 is recognized, in response to the touch position. Thus, a determination signal may be generated, and display of the pull-down menu 43, determination of a menu, determination of an icon, or the like may be performed.

As shown in FIG. 1, since the operation face 6a of the touch pad 6 is provided at the position close to the front side of the stick pointer 10, it may be easy to continuously operate the stick pointer 10 and the operation face 6a with a finger. In addition, it may not be necessary to provide a button only for the stick pointer 10.

In the stick pointer operation mode, when the right button operation area 16a, the right button operation area 16c, the left button operation area 16b, or the left button operation area 16d shown in FIG. 2A or FIG. 2B is merely touched with a finger, the pseudo-button signal may be generated. Also, when a tapping operation of rapidly touching for a short time the right button operation area 16a, the right button operation area 16c, the left button operation area 16b, or the left button operation area 16d with a finger is performed, the pseudo-button signal may be generated. When a double tapping operation of continuously repeating the operation of rapidly touching twice with a finger for a short time is performed, the pseudo-button signal may be generated.

When the stick pointer operation mode is set and the right button operation area 16a, the right button operation area 16c, the left button operation area 16b, or the left button operation area 16d is merely touched or tapped with a finger, the pseudo-button signal may be generated, a determination signal also may be generated on the basis of the pseudo-button signal, and the determination signal may be generated by the button signal at the time of pressing the right button 8 or the left button 9.

When “use both” is selected in the device selection section 31 of the input unit setting menu 30 shown in FIG. 7A, the operation signal generating unit 27 may generate a movement instruction signal on the basis of the pad signal at the time of operating the touch pad 6 and the stick signal at the time of operating the stick pointer 10. In this case, the determination signal may be generated when the right button 8 or the left button 9 is pressed, and the pseudo-button signal may not be generated on the basis of the pad signal.

As shown in FIG. 3, a feedback mechanism 45 may be provided on the back side of the substrate 17 constituting the touch pad 6. The feedback mechanism 45 may have a coil and a magnet, and can give a vibration impact to the touch pad 6 for a short time by repeatedly applying pulse-phase current to the coil. Also, the feedback mechanism 45 may have a piezoelectric element, and may give impact force or impact vibration to the touch pad 6 by allowing current to flow in the piezoelectric element.

When the stick pointer operation mode is set, several areas of the right button operation areas 16a and 16c or the left button operation areas 16b and 16d of the operation face 6a of the touch pad 6 are touched or tapped with fingers, and the pad signal is transmitted to the operation signal generating unit 27, the feedback mechanism 45 may operate by an instruction from the operation signal generating unit 27. The operator can feel the same operation tactile equivalent to pressing the right button 8 or the left button 9 by receiving feedback power from the touch pad 6.

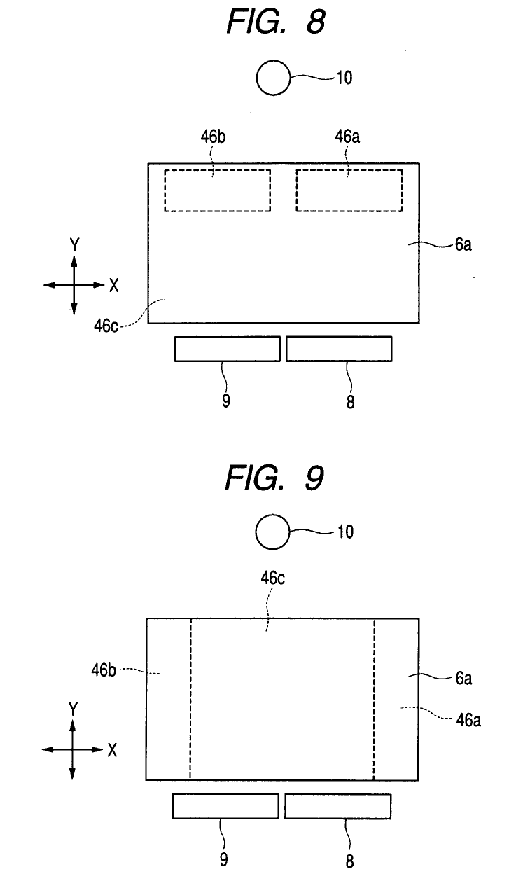

FIG. 8 and FIG. 9 show examples of the other setting of the button operation areas set on the operation face 6a of the touch pad 6.

In the setting example shown in FIG. 8, a right button operation area 46a and a left button operation area 46b may be set as areas separated from each other at two left and right parts on the front side of the operation face 6a of the touch pad 6, and the other area may be set as a pad operation area 46c. In the setting example shown in FIG. 9, right and left areas of the operation face 6a may be set as a right button operation area 46a and a left button operation area 46b, and the other area is set as a pad operation area 46c.

The position and the size of the right button operation area 46a and the left button operation area 46b can be freely changed and set by operating an area designating section of the input unit setting menu 30 as shown in FIG. 7.

At the time of the setting shown in FIG. 8 and FIG. 9, the movement instruction signal can be given by both the coordinate input of the touch pad 6 and the coordinate input of the stick pointer 10.

When the movement instruction signal is generated by operating the stick pointer 10, a determination signal maybe generated by touching or tapping the right button operation area 46a or the left button operation area 46b with a finger.

By touching the pad operation area 46c that is the area other than the button operation areas 46a and 46b with a finger on the operation face 6a and moving the finger, the movement instruction signal may be generated. In this case, when the right button 8 or the left button 9 is pressed, a determination signal may be generated.

In the setting examples shown in FIG. 8 and FIG. 9, parts of the button operation areas 46a and 46b may be illuminated with a light source or coloring or the like may be applied to the button operation areas 46a and 46b, to visually distinguish the button operation areas 46a and 46b from the pad operation area 46c.

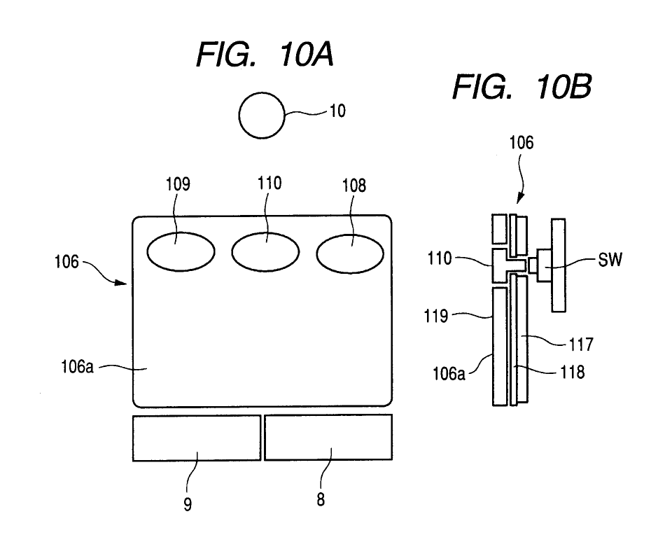

FIG. 10A to FIG. 12B show input processing devices according to various embodiments of the invention.

The input processing device shown in FIG. 10A and FIG. 10B may be provided with a substrate 117 constituting a touch pad 106, an insulating layer 118 having electrodes, and a cover sheet 119 with three holes. Buttons 108, 109, and 110 may be inserted to the holes so as to be pressed and operated, and three switches SW which may be separately operated by the buttons 108, 109, and 110.

The stick pointer 10 may be operated to generate a movement instruction signal from a stick signal, the cursor 41 displayed on the display screen 56 may be moved, and then one of the buttons 108, 109, and 110 may be pressed to operate the switch SW. At this time, it is recognized as a pseudo-button signal, a determination signal may be generated, and determination of a menu or the like may be performed.

An area other than the buttons 108, 109, and 110 of the operation face 106a of the touch pad 106 may be a pad operation area, and a movement signal may be generated even by operating the pad operation area without touching the buttons 108, 109, and 110. In this case, when the right button 8 or the left button 9 is pressed, a button signal may be generated.

In the embodiment shown in FIG. 10B, since the insulating layer 118 having the electrodes is provided on the back side of the buttons 108, 109, and 110, it is possible to detect a touch position when the surfaces of the buttons 108, 109, and 110 are touched with a finger, as information on coordinates. In this case, different operation signals may be generated according to a case of setting the touch pad operation mode and a case of setting the stick pointer operation mode, by the input unit setting menu 30 shown in FIG. 7A.

When the stick pointer operation mode is set and one of the buttons 108, 109, and 110 is pressed, a determination signal associated with the operation of the stick pointer 10 may be generated. When the touch pad operation mode is set, the whole area of the operation face 106a including the surfaces of the buttons 108, 109, and 110 may serve as the pad operation area. When any part of the whole area of the operation face 106a including the buttons 108, 109, and 110 is touched with a finger, a movement instruction signal may be generated. In this case, when the right button 8 or the left button 9 is pressed, the determination signal may be given.

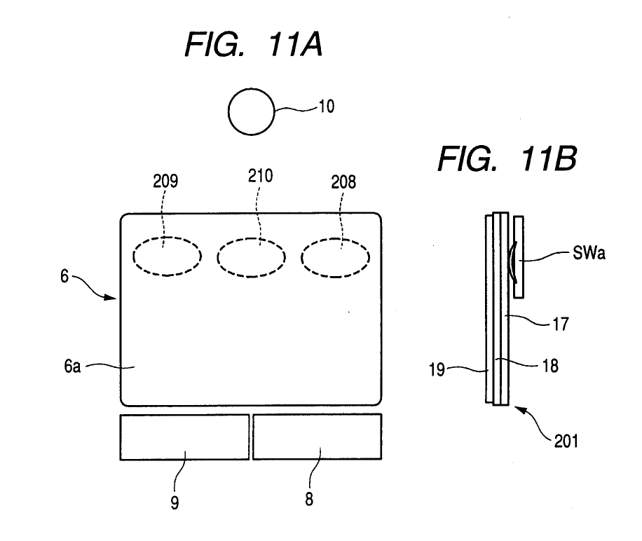

The input processing device shown in FIG. 11A and FIG. 11B may be provided with one switch SWa. The touch pad 6 may be provided on the back face of a hinge 201, and the switch SWa may be swingable about the hinge 201 as a support point and may be pressed when the whole touch pad 6 is swung. Button operation areas 208, 209, and 210 may be set at parts of the operation faces 6a of the touch pad 6. The positions and dimensions of the button operation areas 208, 209, and 210 can be freely set.

When the stick pointer operation mode is set by the input unit setting menu 30 shown in FIG. 7A and the buttons operation areas 208, 209, and 210 are touched with a finger to further press the touch pad 6 and to operate the switch SWa in association with the operation of the stick pointer 10, a pseudo-button signal may be generated from a pad signal of discriminating which button operation area of the button operation areas 208, 209, and 210 is touched with the finger and an operation signal of the switch SWa.

When the touch pad operation mode is set, the whole area of the operation face 6a including the surfaces of the button operation areas 208, 209, and 210 may serve as the pad operation area. Even when any position of the operation face 6a is touched with a finger, a movement instruction signal may be generated. In this case, when the right button 8 or the left button 9 is pressed, a determination signal may be generated.

Also in the embodiments shown in FIG. 10A, FIG. 10B, FIG. 11A, and FIG. 11B, the buttons 108, 109, and 110 and the button operation areas 208, 209, and 210 may be colored in advance or may be partially illuminated with light to distinguish them from the other part of the operation face.

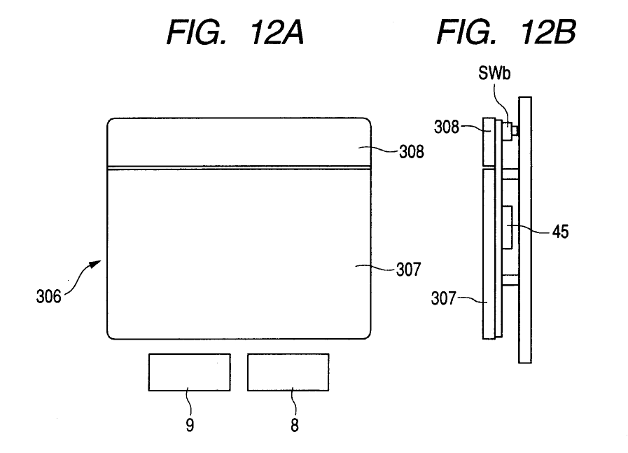

In the embodiment shown in FIG. 12A and FIG. 12B, a wide area on the front side of a touch pad 306 may serve as a fixed unit 307, and a narrow area on the rear side may serve as a movable unit 308. The feedback mechanism 45 may be provided on the back side of the fixed unit 307. When the movable unit 308 is pressed, a switch SWb may be operated. A coordinate position can be detected in the whole area of the fixed unit 307 and the movable unit 308. Accordingly, even when any position is touched with a finger, the coordinate position thereof can be detected.

When the stick pointer operation mode is set and the movable unit 308 is pressed with a finger to operate the switch SWb in association with the operation of the stick pointer 10, a pseudo-button signal may be generated. When the touch pad operation mode is set and several parts of the surface of the whole area of the surfaces of the fixed unit 307 and the movable unit 308 are touched with a finger, a movement instruction signal may be generated.

It should be understood by those skilled in the art that various modifications, combinations, sub-combinations and alterations may occur depending on design requirements and other factors insofar as they are within the scope of the appended claims of the equivalents thereof.

Accordingly, the embodiments of the present inventions are not to be limited in scope by the specific embodiments described herein. Further, although some of the embodiments of the present invention have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. An input processing device comprising:
a touch pad that detects a touch position of a finger;
at least two button operation units that are provided around the touch pad;
a pad signal processing unit that processes a detection signal from the touch pad to generate a pad signal and processes a detection signal from the button operation units to generate a button signal;
a stick pointer that is provided at a position farther away from a user than the touch pad and detects an operation in the tilting direction;
a stick signal processing unit that processes a detection signal from the stick pointer to generate a stick signal; and
an operation signal generating unit that receives the pad signal, the button signal, and the stick signal,
wherein in the operation signal generating unit, a movement instruction signal about information displayed on a screen is generated when receiving the pad signal, a determination signal associated with the movement instruction signal based on the pad signal is generated when receiving the button signal, a movement instruction signal about information displayed on the screen is generated and the pad signal is recognized as a pseudo-button signal when receiving the stick signal, a determination signal is generated associated with the movement instruction signal based on the stick signal is generated when receiving the pseudo-button signal, and
wherein the touch pad, the stick pointer, and the button operation units are provided in a narrow space.

2. The input processing device according to claim 1, wherein any area of the operation face of the touch pad is set as a button operation area, and the pad signal is recognized as the pseudo-button signal when the button operation area is touched with a finger.

3. The input processing device according to claim 2, wherein the position and size of the button operation area are set by an operation signal.

4. The input processing device according to claim 1, wherein the operation signal generating unit recognizes whether a touch pad operation mode is set or a stick pointer operation mode is set, and
wherein the movement instruction signal is generated by the pad signal when the touch pad operation mode is set, and the pseudo-button signal is generated by the pad signal when the stick pointer operation mode is set.

5. The input processing device according to claim 4, wherein the touch pad operation mode and the stick pointer operation mode are switched with each other by an operation signal.

6. The input processing device according to claim 4, further comprising a feedback mechanism that gives feedback power to the touch pad when the stick pointer operation mode is set and it is detected that the touch pad is touched with the finger.

7. The input processing device according to claim 1, further comprising a switch that operates when at least apart of the touch pad is pressed, wherein the pseudo-button signal is generated when receiving a detection signal of the switch.

8. The input processing device according to claim 1, wherein a cursor displayed on the screen is moved by the movement instruction signal, and a detailed menu corresponding to a position instructed by the cursor is displayed by the determination signal or a selected menu is determined by the determination signal.
